(19) United States
(12) Patent Application Publication
(10) Pub. No.: US 2026/0232129 A1
(43) Pub. Date: Aug. 13, 2026

(54) AN ELECTRIC KETTLE AND A METHOD OF ASSEMBLY

(71) Applicant: Aarke AB, Stockholm (SE)

(72) Inventors: Melker MAGNERIUS, Stockholm (SE); Pedro ZEMBORAIN, Stockholm (SE)

(73) Assignee: Aarke AB, Stockholm (SE)

(21) Appl. No.: 19/150,309

(22) PCT Filed: Jan. 24, 2024
(86) PCT No.: PCT/EP2024/051633

§ 371 Date: Jul. 23, 2025

(30) Foreign Application Priority Data
Jan. 26, 2023 (SE) 2350069-7

(51) Int. Cl. A47J 27/21

(52) U.S. Cl. CPC A47J 27/21166; A47J 27/2105

(57) ABSTRACT

An electric kettle comprising an outer enclosure comprising an enclosure outlet end and an inner container completely arranged within the outer enclosure, wherein the electric kettle is configured such that, during assembly, the inner container is insertable into the outer enclosure through the enclosure outlet end. A method of assembling an electric kettle.

### PRIORITY

This patent application is an International PCT patent application, which claims priority to Swedish patent application no. 2350069-7 with the title “AN ELECTRIC KETTLE AND A METHOD OF ASSEMBLY” filed on Jan. 26, 2023.

### TECHNICAL FIELD

The present disclosure generally pertains to an electric kettle, more particularly to an electric kettle comprising an outer enclosure and an inner container.

### BACKGROUND ART

There exists a great variety of electric kettles. Many prior art kettles suffer from various drawbacks such as poor durability and reparability, and loud noise. Furthermore, such kettles may comprise many parts and predominantly be made of polymer material.

### SUMMARY OF THE INVENTION

It is an aim of the present disclosure to provide an improved electric kettle. Improvements may relate to a design that facilitates repair, lower noise and long life.

There is provided an electric kettle that comprises an outer enclosure comprising an enclosure outlet end and an inner container completely arranged within the outer enclosure. The electric kettle is configured such that, during assembly, the inner container is insertable into the outer enclosure through the enclosure outlet end.

The outer enclosure and the inner container may together result in a relatively silent electric kettle, which is well thermally insulated. Thereby, both outer enclosure and the inner container may be made of metal, which in turn may lead to long life. Since the inner container is insertable into the outer enclosure through the enclosure outlet, an opposite end of the outer enclosure need not be designed to let the inner container pass there through. Thereby, the outer enclosure may be formed in one-piece and have a tapered base end, which may be advantageous for durability. For example, the outer enclosure may be a one-piece metal part. The inner container may also be a one-piece metal part. A preferred metal for both the outer enclosure and the inner container is stainless steel.

The outer enclosure and the inner container may extend axially straight along a major portion of the electric kettle. Such a design may be room efficient, e.g. have a smaller footprint, as compared to for example a more spherical kettle.

The inner container may be detachably attached to the outer enclosure by a screw connection, allowing relatively easy repair as compared to welded or glued solutions.

The inner container may comprise an inner support and the outer enclosure may comprise an outer support, wherein the inner support may rest on the outer support. In other words, the inner container may be suspended on the outer enclosure. Such an electric kettle may be durable and relatively easy to assemble and disassemble, and involve few parts.

A sealing element may be arranged between the inner support and the outer support to lower noise and to hinder humidity from entering in-between the inner container and the outer enclosure.

There may be a screw connection forcing the inner support of the inner container towards the outer support of the outer enclosure. This may be beneficial for durability and ease of repair.

The electric kettle may comprise a strainer. The kettle may comprise a bracket structure configured to hold a first end of the strainer, and a support bracket that is configured to hold a second end of the strainer. The bracket structure may be adapted to the shape of the first end of the strainer and the support bracket may comprise a strainer receiver that is adapted to the shape of the second end of the strainer. The bracket structure and the strainer receiver may comprise recesses that cooperate with the elastic strainer, or with elastic portions of the strainer. The strainer may be made entirely of metal, such as stainless steel. Such a solution for providing a kettle strainer made entirely of metal may also find use in electric kettles of other designs than the one described herein.

The electric kettle may comprise a lid. An opening movement of the lid may be braked by a brake assembly. In particular, the opening movement of the lid may be braked, or slowed, at the end of the opening movement. The brake assembly may be positioned at a position that is relatively well thermally insulated from heated water and steam that is generated by the electric kettle. Such a placement of the brake assembly may be beneficial as the braking ability of the brake assembly may be affected by heat. Such a solution for providing a kettle lid with a braked opening movement may also find use in electric kettles of other designs than the one described herein.

There is further provided a method of assembling an electric kettle comprising an outer enclosure and an inner enclosure. The method comprises inserting the inner container inside the outer enclosure through an enclosure outlet end and tightening a screw connection to force the inner container towards the outer enclosure and to detachably attach inner container to the outer enclosure.

A heater element may be secured to the container base end, and the screw connection that is tightened may be connected to the heater element.

### BRIEF DESCRIPTION OF THE DRAWINGS

The present invention will be described further below by way of example and with reference to the enclosed drawings, in which:

FIG. 1 shows an electric kettle,

FIG. 2 is a partial cut-away illustration, slightly from above, of the electric kettle of FIG. 1,

FIG. 3 shows an outer enclosure and an inner container of the electric kettle of FIGS. 1 and 2, and schematically illustrates a method of assembling an electric kettle,

FIG. 4 corresponds to FIG. 2, but is a view slightly from below,

FIG. 5 is an exploded view of a base end of the electric kettle of FIGS. 1 and 2,

FIG. 6 is an enlarged view of an area where an inner container rests on an outer enclosure of the electric kettle of FIGS. 1 to 4, and

FIG. 7 is an enlarged view of the area of a pouring spout of the electric kettle of FIGS. 1 to 4.

### DETAILED DESCRIPTION OF EMBODIMENTS

Embodiments of the present disclosure will now be described more fully hereinafter with reference to the accompanying figures. Like reference numbers refer to like elements throughout the description and figures.

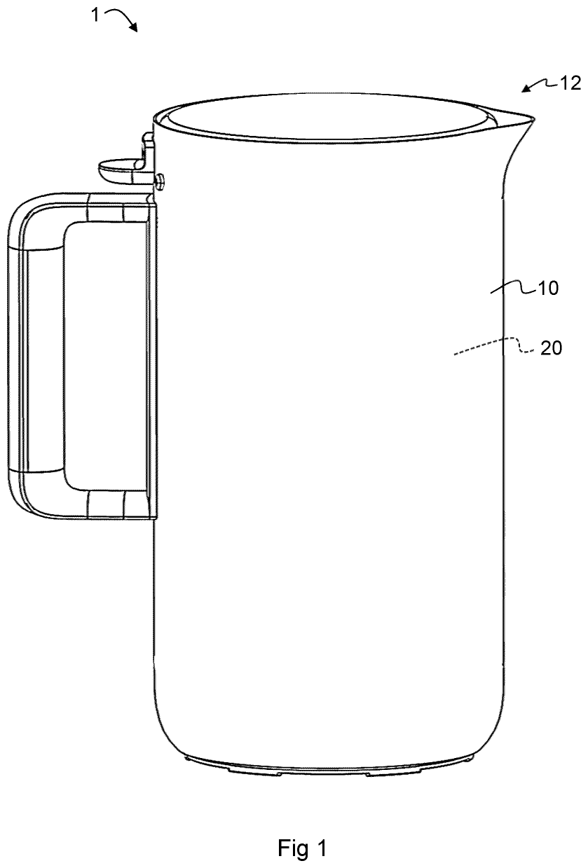

FIGS. 1 to 7 show an electric kettle 1 of a kind that typically is used to heat tap water, purified tap water or bottled water. The electric kettle 1 may be adapted to be placed on, controlled and electrically powered by, an undepicted separate kettle stand or kettle base unit that is connected to mains. In other embodiments, the electric kettle 1 may comprise a power cord and be directly connected to mains.

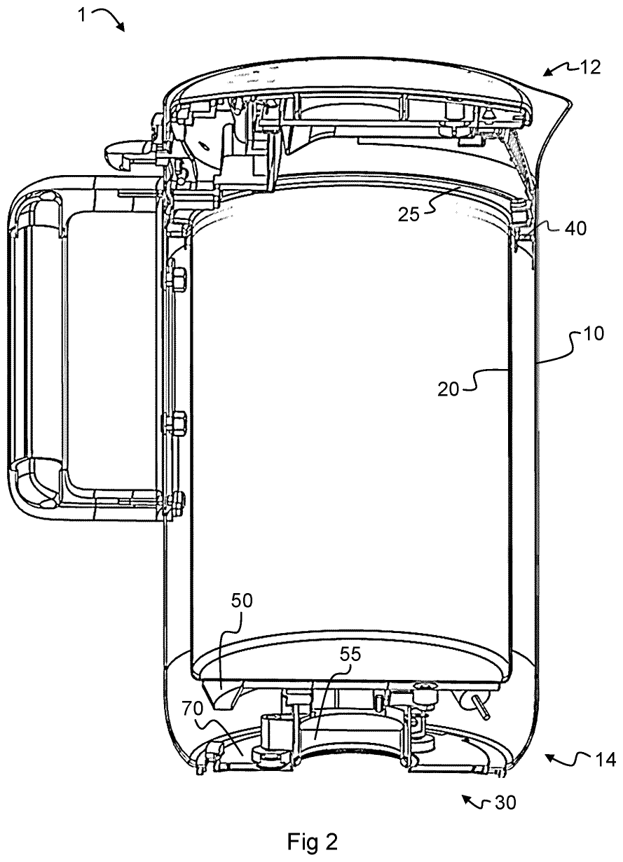

The electric kettle 1 comprises an outer enclosure 10 and an inner container 20 that is completely arranged within the outer enclosure 10, as is shown in FIGS. 2 to 4. After assembly, the inner container 20 is not visible from the outside of the electric kettle 1. The electric kettle 1 may further comprise (see e.g. FIG. 2) a handle, a lid and a lid actuator to be pushed by a user to open the lid.

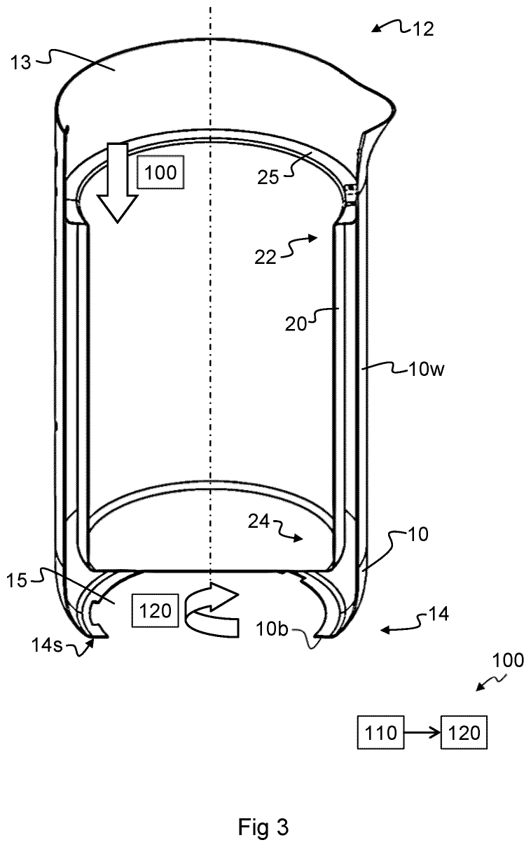

The electric kettle 1 is configured such that, during assembly, the inner container 20 is insertable into the outer enclosure 10 through an enclosure outlet end 12, as is illustrated by the hollow straight arrow in FIG. 3.

The outer enclosure 10 may be one-piece. Thus, the outer enclosure 10 may be made of one single material. Typically, the outer enclosure 10 radially surrounds the inner container 20 and extends axially past the opposite axial ends of the inner container 20.

The outer enclosure 10 may comprise an enclosure base end 14 (denoted in FIGS. 2 and 3) that is smaller than the enclosure outlet end 12. In other words, the outer enclosure 10 may taper at its base end 14. In the current example, the enclosure base end 14 is rounded.

Referring again to FIG. 3, the enclosure base end 14 may define an enclosure base surface 14s and the outer enclosure 10 may extend continuously from the enclosure base surface 14s to the enclosure outlet end 12. As in the current example, the enclosure base surface 14s may extend substantially in parallel with a surface on which the electric kettle 1 stands. The outer enclosure 10 may extend continuously from an underside of the electric kettle 1 to the enclosure outlet end 12. Thus, in a side view, the electric kettle 1 be free from any breaks, splits, crevices or similar.

In other words, the outer enclosure 10 may comprises a lateral sidewall portion and a bottom wall portion and the lateral sidewall portion may seamlessly transition to the bottom wall portion. The seamless transition may be rounded. Referring e.g. to FIG. 1, the outer enclosure 10 may be circular cylindrical with a rounded circumferential bottom edge.

As is shown in FIGS. 1 to 4, the outer enclosure 10 and the inner container 20 may extend axially straight along a major portion of the longitudinal direction of the electric kettle 1, a major portion being defined as at least 50 percent. In the current embodiment, the outer enclosure 10 extends axially straight along approximately 90 percent of the electric kettle 1, a plausible range being 80 to 95 percent. Further, the inner enclosure 20 extends axially straight along approximately 70 percent of the electric kettle 1, a plausible range being 60 to 80 percent. In the present embodiment, the outer enclosure 10 and the inner container 20 extend vertically when the electric kettle 1 stands on a horizontal surface.

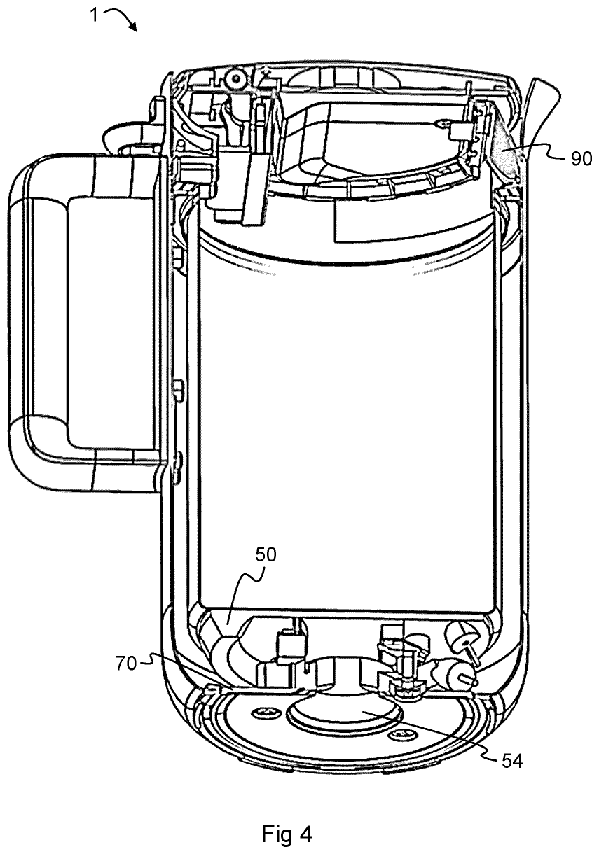

As will be exemplified below with reference to FIGS. 2 and 4, the inner container 20 may be detachably attached to the outer enclosure 10 by a screw connection 30.

Referring in particular to FIG. 3, the outer enclosure 10 may define an enclosure outlet opening 13 and an enclosure base opening 15. As is apprehended from the figure, the enclosure outlet opening 13 is arranged at the enclosure outlet end 12, e.g. at the end where water is poured out from the electric kettle 1. The enclosure outlet opening 13 may comprise a spout, as is shown. The inner container 20 may be smaller than the enclosure outlet opening 13 but larger than the enclosure base opening 15. Thus, the inner container 20 may be insertable through the enclosure outlet opening 13 but not through the enclosure base opening 15.

The edge of the base opening 15 may form the enclosure base surface 14s. The edge of the base opening 15, and thus the enclosure base surface 14s, may be annular. The edge of the base opening 15 may comprise one or more radial recesses (FIG. 3, left side of base opening 15) for rotationally fixing an enclosure cover 70.

Further, referring to the figures, the inner container 20 may comprise an inner support 25 and the outer enclosure 10 may comprise an outer support 40. The inner support 25 may rest on the outer support 40. Thus, the inner container 20 may rest on, i.e. be carried by, the outer enclosure 10.

In the present embodiment, the inner container 20 extends from a container outlet end 22 that is open to a container base end 24 that is closed. Referring e.g. to FIG. 3, the inner container 20 may be circular cylindrical. The inner support 25 is typically located closer to the container outlet end 22 than to the container base end 24. In the current embodiment, the inner support 25 is located at the container outlet end 22, more precisely is a flange that extends radially outwards at the container outlet end 22. The inner support 25 may thus be annular and extend around the entire circumference of the inner container 20. In undepicted embodiments, the inner support 25 may be one or several separate components that are attached to the inner container 20.

The outer support 40 is typically located closer to the enclosure outlet end 12 than to the enclosure base end 14. In the current embodiment, the outer support 40 is located at a distance from the enclosure outlet end 12, which distance corresponds to approximately 20 percent of the longitudinal extension (height) of the outer enclosure 10. A suitable range for said distance is 10 to 35 percent.

In the current example, the outer support 40 is a separate component that is attached internally to the outer enclosure 10. If the outer support 40 is to be attached to the outer enclosure 10, e.g. by welding, the outer support 40 preferably has an outer portion that is adapted to lie flat against the inner surface of the outer enclosure 10. Further, the outer support 40 preferably has a support portion on which the inner support 25 may stably rest, and an inner portion that is not likely to scratch the outer enclosure 10 during assembly, and that provides strength to the support portion. The current outer support 40 essentially has the profile of an upside-down J.

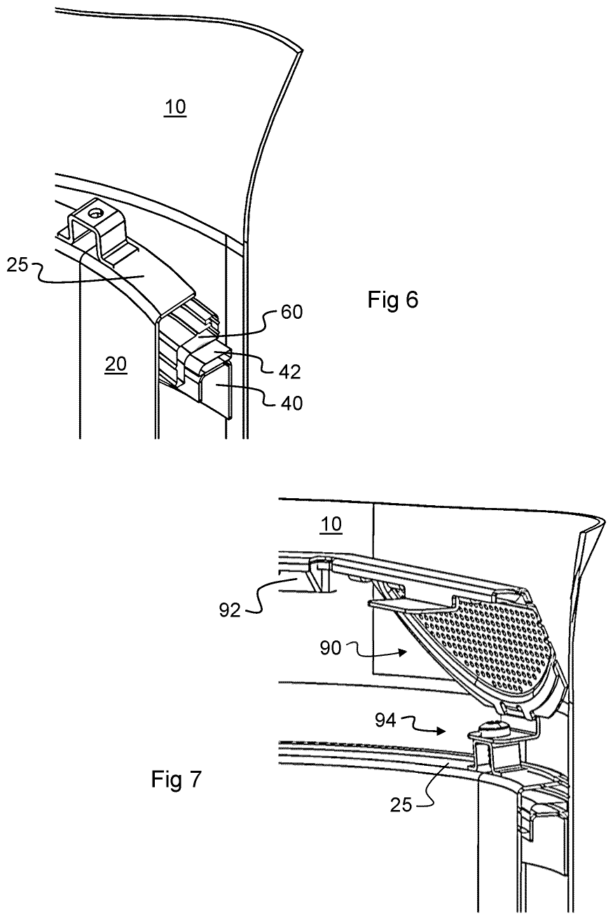

The outer support 40 may be a separate annual component that extends along the entire inner circumference of the outer enclosure 10. Alternatively, the outer support may be formed by two or more sections that each extend along a part of the inner circumference of the outer enclosure 10. Such separate sections may facilitate assembly. If the outer support is formed of separate sections, an optional ring 42 (FIG. 6) may be positioned on such separate sections to provide a circumferentially continuous surface, which may be beneficial for sealing purposes. The ring 42 may be formed of polymer material.

The outer support 40 may alternatively, in undepicted embodiments, be formed by a deformed section of the outer enclosure 10, such as a bulge or a local radius reduction.

A sealing element 60 may be arranged between the inner support 25 of the inner container 20 and the outer support 40 of the outer enclosure 10, see in particular FIG. 6. The sealing element 60 may, as is shown, be configured to wrap around a radially outer edge of the inner support 25. The sealing element may be adapted to seal between the support portion of the outer support 40 and the inner support 25. The sealing element may further be adapted to seal between the inner portion of the outer support 40 and the inner container 20. The current sealing element 60 essentially has an S-profile. The sealing element 60 is preferably of an elastic material, such as rubber, such that the sealing element 60 provides good sealing and in addition absorbs vibrations. The current sealing element 60 is made from silicone rubber. The sealing element 60 may be referred to as a sealing and vibration-dampening element.

If the inner support 25 is located at the container outlet end 22, the inner support 25 will typically be located above the water level of the inner container 20 when the electric kettle 1 is in the upright position. Thus, when the electric kettle 1 is operated to heat water, the water level will typically be below the inner support 25. It follows that in this situation, the sealing element 60 will typically be located above the water level.

There may be provided a screw connection 30 to force the inner support 25 towards the outer support 40. Thereby, the sealing provided by the sealing element 60 may be particularly tight, and disassembly of the electric kettle 1 may be facilitated. The screw connection 30 may compress the sealing element 60 between the inner support 25 and the outer support 40.

The outer enclosure 10 and the inner container 20 may provide a double-wall electric kettle 1, which is relatively well insulated both thermally and acoustically. The acoustic insulation may be further improved by the sealing element 60 that is arranged between the outer enclosure 10 and the inner container 20. It is believed that noise may be generated as the water is heated inside the inner container 20, caused by water changing from liquid to gas. By means of the present design, resulting vibrations of the inner container 20 may at least partly be prevented from transferring to the outer enclosure 10. There may be no or only a very limited direct contact between the outer enclosure 10 and the inner container 20. If the outer enclosure 10 and the inner container 20 are made of metal, there may be very limited or no metal-to-metal contact between the outer enclosure 10 and the inner container 20.

As is apprehended from FIGS. 2 to 5, the screw connection 30 may be configured to force the inner container 20 towards the enclosure base end 14. This may be obtained by the screw connection 30 being connected to the container base end 24 of the inner container 20 and to the enclosure base end 14.

Referring in particular to FIGS. 2, 4 and 5, there may be a heater element 50 secured to the container base end 24 of the inner container 20, more precisely to its external bottom end. The heater element 50 may be soldered or brazed to the container base end 24. The screw connection 30 may be connected to the container base end 24 via the heater element 50. Further, there may be an enclosure cover 70 provided to cover the enclosure base end 14. The enclosure cover may abut against the enclosure base end 14, and the screw connection 30 may be connected to the enclosure base end 14 via the enclosure cover 70.

In some more detail, the screw connection 30 may comprise at least one, but preferably a number of threaded fasteners 34, 38 and corresponding fastener receivers 32, 36. The threaded fasteners 34, 36 may be screws or bolts and the fastener receivers 32, 36 may be internally threaded holes.

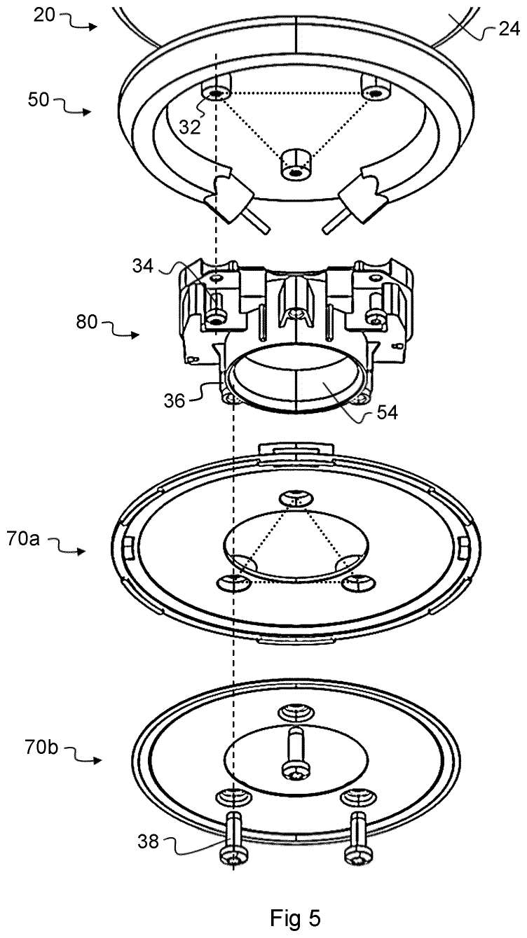

As is best shown in the exploded view of FIG. 5, the electric kettle 1 may comprise a support structure 80 that i.a. serves the function of attaching the inner container 20 to the outer enclosure 10. The support structure 80 may further comprise an electrical connector 54, electric wires leading from the electrical connector 54 to the heater element 50, fuses and a temperature sensor.

In the present embodiment, the support structure 80 is attached to the heater element 50 and to the enclosure cover 70. Thus, the inner container 20 is attached to the outer enclosure 10 via the support structure 80.

In the embodiment of FIG. 5, there are heater fastener receivers 32 formed integrally with, or secured to, the heater element 50. The support structure 80 is screwed to the heater element 50 by means of heater threaded fasteners 34 in the form of screws. Further, there are support fastener receivers 36 formed integrally with the support structure 80. The enclosure cover 70 is screwed to the support structure 80 by means of support threaded fasteners 38 in the form of screws.

The support structure 80 is preferably a rigid structure that may carry the force required for attaching, in the current case clamping, the inner container 20 to the outer enclosure 10. Typically, the support structure 80 is made of polymer material. The support structure 80 made be of a material that at least to some extent dampens vibrations, such that noise generated inside the inner container 20 at least to some extent is prevented from being transferred to the outer enclosure 10.

The enclosure cover 70 may be one-piece or may comprise a load-bearing part 70a and a cover part 70b. The one-piece enclosure cover 70, or its load-bearing part 70a, is preferably a rigid structure as it may function to rest against the enclosure base end 14 to, optionally via the support structure 80, attach (clamping) the inner container 20 to outer enclosure 10. The enclosure cover 70 (here its load-bearing part 70a) may comprise an annular bearing surface that is configured to abut against the enclosure base end 14. In the present example, the annular bearing surface of the load-bearing part 70a abuts against the enclosure base surface 14s. The above-mentioned radial recesses of the base opening 15 may receive corresponding protrusions of the load-bearing part 70a (see FIG. 4, and FIGS. 3 and 5 in conjunction).

Even though the number of heater threaded fasteners 34 and support threaded fasteners 38 may be selected relatively arbitrary, using three heater threaded fasteners 34 and threaded fasteners 38 is considered advantageous. A smaller number of fasteners 34, 38 may result in a less stable connection, and a greater number may lead to increased costs and weight. As is illustrated by the dotted triangles in FIG. 5, the heater fastener receivers 32 and the corresponding heater threaded fasteners 34 are preferably arranged in a triangular pattern. Similarly, the support fastener receivers 36 and the support threaded fasteners 38 are preferably arranged in a triangular pattern. The two triangular patterns may be angularly offset to provide a compact solution. In the current example, the triangular patterns are angularly offset 120 degrees.

The position of the electrical connector 54 within the support structure 80 is indicated in FIGS. 4 and 5 but the actual connector is not shown.

The outer enclosure 10 and the inner container 20 are typically made of metal, such as stainless steel. Both may be thin-walled.

A method 100 of assembling an electric kettle 1, essentially of the kind described herein, is illustrated in FIG. 3 (hollow arrows and box diagram). The method comprises inserting 110 an inner container 20 inside an outer enclosure 10 through an enclosure outlet end 12 of the outer enclosure 10. The method further comprises tightening 120 a screw connection 30 to force the inner container 20 towards the outer enclosure 10 and to detachably attach inner container 20 to the outer enclosure 10. A method for disassembling the electric kettle 1 correspondingly comprises loosening the screw connection 30 and taking the inner container 20 out from the outer enclosure 10 through the enclosure outlet end 12. Such a method, not involving the inner container 20 passing through an enclosure base end 14 of the outer enclosure 10, allows for a one-piece outer enclosure 10 comprising an enclosure base end 14 that is smaller than the enclosure outlet end 12.

During use, the inner container 20 contains the water to be heated. The outer enclosure 10 contains the inner container 20, the heating assembly 50 and the lid mechanism. The user is not expected to fill the electric kettle 1 with water to a level that is above the inner container 20. In any case, the sealing element 60 prevents water and steam from entering in-between the inner container 20 and the outer enclosure 10.

Typically, the kettle base unit may comprise a user interface and electronics for operating the electric kettle 1. Thus, the electric kettle 1 (free from such interface and electronics) may be particularly sturdy, tough and resistant to wear and tear.

FIG. 7 shows a filter or strainer 90 that may be attached to strain water before being poured out from a kettle, such as the present electric kettle 1. As illustrated, the strainer 90 may be arranged upstream a spout.

An enclosure bracket structure 92, in the present embodiment annular is shape, may attached internally to the outer enclosure 10 (or a similar enclosure), to hold a first end of the strainer 90. A second end of the strainer may be held by the inner support 25. The strainer 90 may be at least partly elastic and be attached to the electric kettle 1 by being snap-fit between the enclosure bracket structure 92 and the inner support 25. More in detail the inner support 25 may comprise a support bracket that holds the second end of the strainer 90. In the current example, the support bracket comprises a bridge-shaped holder that is welded to the inner support 25 and a U-shaped strainer receiver.

As is illustrated, the enclosure bracket structure 92 may be adapted to the shape of the first (upper) end of the strainer 90 and the strainer receiver may be adapted to the shape of the second (lower) end of the strainer 90. The enclosure bracket structure 92 and the strainer receiver may comprise recesses that cooperate with the elastic strainer 90, or elastic portions of the strainer 90. In this manner, the strainer 90 may be made entirely of metal, such as stainless steel.

As shown in FIGS. 1, 2 and 4, the electric kettle 1 typically comprises a lid. The lid may comprise an internal (lower) wall and an external (upper) wall. Thus, the lid may be double-walled to provide thermal and acoustic insulation. The lid may find use in kettles in other designs. The lid may be hinged to the outer enclosure 10 (or a seminal enclosure). There may be provided a spring arrangement that biases the lid towards an open position, and a ratchet arrangement that keeps the lid in a closed position (FIG. 1). Operation of the lid actuator (left lever in FIG. 1) may release the ratchet arrangement such that the lid pivots to the open position. Preferably, the opening movement of the lid is braked by a brake assembly. In particular, the opening movement of the lid may be braked, or slowed, at the end of the opening movement.

The lid and its operating mechanism is illustrated in FIGS. 2 and 4. Even though not described in detail herein, the brake assembly may be positioned at a position that is relatively well thermally insulated from the heated water and steam that is generated by the electric kettle 1. Such a placement of the brake assembly may be beneficial as the braking ability of the brake assembly may be affected by heat.

Modifications and other variants of the described aspects and embodiments will come to mind to one skilled in the art having benefit of the teachings presented in the foregoing description and associated drawings. Therefore, it is to be understood that the embodiments are not limited to the specific example aspects and embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims.

As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. An electric kettle comprising
an outer enclosure comprising an enclosure outlet end and
an inner container completely arranged within the outer enclosure, wherein the electric kettle is configured such that, during assembly, the inner container is insertable into the outer enclosure through the enclosure outlet end.

2. The electric kettle of claim 1, wherein the outer enclosure is one-piece.

3. The electric kettle of claim 1, wherein the outer enclosure comprises an enclosure base end that is smaller than the enclosure outlet end.

4. The electric kettle of claim 3, wherein the enclosure base end defines an enclosure base surface and the outer enclosure extends continuously from the enclosure base surface to the enclosure outlet end.

5. The electric kettle of claim 1, wherein the outer enclosure and the inner container extend axially straight along a major portion of the electric kettle.

6. The electric kettle of claim 1, wherein the inner container is detachably attached to the outer enclosure by a screw connection.

7. The electric kettle of claim 1, wherein the outer enclosure defines an enclosure outlet opening and an enclosure base opening, and the inner container is smaller than and thus insertable through the enclosure outlet opening but larger than and thus not insertable through the enclosure base opening.

8. The electric kettle of claim 1, wherein the inner container comprises an inner support and the outer enclosure comprises an outer support, the electric kettle being configured such that the inner support may rest on the outer support.

9. The electric kettle of claim 8, wherein the inner support is located closer to a container outlet end than to a container base end of the inner container and the outer support is located closer to the enclosure outlet end than to an enclosure base end of the outer enclosure

10. The electric kettle of claim 8, comprising a sealing element that is arranged between the inner support of the inner container and the outer support of the outer enclosure.

11. The electric kettle according to claim 8, comprising a screw connection that is configured to force the inner support of the inner container towards the outer support of the outer enclosure.

12. The electric kettle of claim 11, wherein the screw connection is connected to a container base end of the inner container and to an enclosure base end of the outer enclosure.

13. The electric kettle of claim 12, comprising a heater element that is secured to the container base end and an enclosure cover that is adapted to abut against the enclosure base end, wherein the screw connection is connected to the heater element and optionally to the enclosure cover.

14. The electric kettle of claim 1, wherein the outer enclosure and/or the inner container are made of metal, such as stainless steel.

15. The electric kettle of claim 3 and according to any preceding claim, wherein the outer enclosure tapers at its enclosure base end and the enclosure base end is rounded.

16. The electric kettle of claim 3, wherein;
the inner container is detachably attached to the outer enclosure by a screw connection;
the outer enclosure defines an enclosure outlet opening and an enclosure base opening, and the inner container is smaller than and thus insertable through the enclosure outlet opening but larger than and thus not insertable through the enclosure base opening; and
comprising a screw connection that is configured to force the inner support of the inner container towards the outer support of the outer enclosure.

17. The electric kettle of claim 16, wherein the screw connection comprises three threaded fasteners arranged in a triangular pattern.

18. A method of assembling an electric kettle comprising an outer enclosure and an inner enclosure, the method comprising
inserting the inner container inside the outer enclosure through an enclosure outlet end and
tightening screw connection to force the inner container towards the outer enclosure and to detachably attach inner container to the outer enclosure.

19. The method of claim 18, wherein a heater element is secured to the container base end.

20. The method of claim 19, wherein the screw connection is connected to the heater element.
